(19) United States
(12) Patent Application Publication
(10) Pub. No.: US 2025/0116837 A1
(43) Pub. Date: Apr. 10, 2025

(54) JACKETED UNDERSEA FIBER OPTIC TELECOMMUNICATIONS CABLE JOINT WITH NON-METALLIC STRENGTH MEMBER

(71) Applicant: SUBCOM, LLC, Eatontown, NJ (US)

(72) Inventors: Christopher Gatson, Englishtown, NJ (US); Marsha Spalding, Hampton, NJ (US); Jeremiah Mendez, Bayville, NJ (US)

(73) Assignee: SUBCOM, LLC, Eatontown, NJ (US)

(21) Appl. No.: 18/906,468

(22) Filed: Oct. 4, 2024

Related U.S. Application Data
(60) Provisional application No. 63/542,591, filed on Oct. 5, 2023.

(51) Int. Cl. G02B 6/44

(52) U.S. Cl. CPC G02B 6/4471

(57) ABSTRACT

Disclosed is a joint assembly for an optical cable. In some embodiments, the joint assembly may include a termination assembly adjacent to a joint, enclosed in a boot assembly, wherein the termination assembly electrically connects, or grounds, a first optical cable and a second optical cable. The termination assembly may include a heat shrink layer surrounding a core of the optical cable, wherein the core comprises a plurality of fibers surrounded by a plurality of strength members, and a first tape layer formed around the heat shrink layer. The termination assembly may further include a non-metallic gripping layer formed over the first tape layer, a second tape layer formed over the non-metallic gripping layer, and a non-metallic material formed over the second tape layer.

### CROSS-REFERENCE TO RELATED APPLICATION

This application claims priority to U.S. provisional patent application Ser. No. 63/542,591 filed on Oct. 5, 2023, entitled “Jacketed Undersea Fiber Optic Telecommunications Cable Joint with Non-Metallic Strength Member,” which is incorporated herein by reference in its entirety.

### BACKGROUND OF THE DISCLOSURE

### Field of the Invention

Embodiments of the present disclosure relate to the field of optical communication systems. More particularly, the present disclosure relates to an improved jacketed undersea optical cable joint having a non-metallic strength member applique.

### Discussion of Related Art

Undersea optical telecommunications cables are a primary backbone of international communications. They are installed across the globe, connecting continents and islands together in support of information communication (e.g., the world wide web). In many areas of the oceans, hazardous subsea conditions cannot be avoided and thus extra protective layers are added to deep sea, lightweight cables. These layers aid in ensuring that the cable withstands external aggression, which often includes man-made threats such as fish aggregation devices (FADs).

Protective layers can take the form of steel wires over the lightweight cable, as in armored cable, or a plastic-jacket layer with optional underlying metallic tape(s) wrapped over the lightweight cable; the latter approach providing superior cable handling characteristics in the deep ocean.

When manufacturing, installing, and maintaining these undersea cables, cable sections need to be joined to one another via undersea joints and to the opto-electric undersea network element units via couplings. These joints must maintain not only the optical, electrical, and mechanical characteristics of the lightweight cable, but also the mechanical strength and protection of the additional protective layers.

It can be challenging to design and implement joints and couplings which maintain the integrity of the external protective layers. It is crucial that all of the heterogenous layers of the cable are physically coupled to one another at the joint/coupling so they function as an integral structure. Each layer should be able to strain approximately the same amount when the cable is subjected to tension, while also accommodating differential strains when the cable is subjected to bending. The heterogeneous layers should have good interlayer mechanical coupling in both the cable itself as well as in joints. This cohesion is critical for cable handling robustness to maintain long term electrical and optical performance for system installation and maintenance. A lack of interlayer mechanical coupling may compromise the optical, electrical, and mechanical characteristics of the undersea cable and jeopardize the long term integrity of the cable system.

It is with respect to these and other drawbacks of the prior art that the present disclosure is provided.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one approach, a joint assembly for connecting optical cables may include a boot assembly, and a termination assembly adjacent the joint, wherein the termination assembly links a first optical cable and a second optical cable for electrical continuity, or links an optical cable to an electrical ground external to the boot assembly. The termination assembly may include a heat shrink layer surrounding a portion of the core and a portion of the external layer of the an optical cable. The core comprises a plurality of fibers surrounded by a plurality of strength members and protective layers. The termination assembly may further include a first tape layer formed around the heat shrink layer, a non-metallic gripping layer formed over the first tape layer, a second tape layer formed over the non-metallic gripping layer, and a non-metallic material formed over the second tape layer.

In another approach, a termination assembly for connecting optical cables may include a heat shrink layer surrounding a portion of the core and a portion of the external layer of an optical cable, a first tape layer formed around the heat shrink layer, and a non-metallic gripping layer formed over the first tape layer. The termination assembly may further include a second tape layer formed over the non-metallic gripping layer, a non-metallic material formed over the second tape layer, and a spacer layer formed over the non-metallic material.

In still yet another approach, a method of forming a termination assembly when jointing undersea cables may include forming a heat shrink layer around a portion of the core and a portion of the external layer of the undersea cable, wherein the core comprises a plurality of fibers surrounded by a plurality of strength members, and wrapping a first tape layer around the heat shrink layer. The method may further include forming a non-metallic gripping layer over the first tape layer, wrapping a second tape layer over the non-metallic gripping layer, forming a non-metallic material over the second tape layer, forming a spacer layer over the non-metallic material, and wrapping a third tape layer over the spacer layer and over the non-metallic material.

### BRIEF DESCRIPTION OF THE DRAWINGS

By way of example, embodiments of the disclosure will now be described, with reference to the accompanying drawings, in which:

FIG. 1 illustrates an example optical communication joint assembly of an undersea cable with completed termination assembly according to embodiments of the present disclosure;

FIG. 2 illustrates a side cross-sectional view of a termination assembly of the joint according to embodiments of the present disclosure;

FIG. 3 illustrates a close-up side cross-sectional view of a portion of the termination assembly according to embodiments of the present disclosure;

FIG. 4 illustrates an end cross-sectional view of a portion of the termination assembly according to embodiments of the present disclosure; and

FIGS. 5-10 illustrate assembly/formation of the termination assembly according to embodiments of the present disclosure.

Certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DESCRIPTION OF EMBODIMENTS

The present disclosure will now be described more fully hereinafter with reference to the accompanying drawings, in which preferred embodiments of the invention are shown. This disclosure, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

Embodiments of the present disclosure relate to jointing techniques that provide a cost-effective and quick means of providing interlayer mechanical coupling between heterogeneous layers of a jacket-protected undersea fiber optic telecommunications cable. As will be described, embodiments of the disclosure utilize a non-metallic strength member applique (e.g., Kevlar) which is both strong and flexible, to ensure the structural integrity of the cable ends entering the joint or coupling. More specifically, the non-metallic strength member is a flexible sleeve that grips adjacent layers and mechanically couples them together to maintain a cohesive structure at the cable-to-joint/coupling interface. Beneficially, this interlayer coupling is achieved without using the common approaches of metallic hardware, adhesives, or epoxies. In some embodiments, the non-metallic strength member may be wrapped with a layer of non-metallic material (e.g., polypropylene) to maintain its position.

At least the following advantages of the present disclosure are achieved over former approaches. Firstly, the non-metallic strength applique is quick and easy to apply, as it does not require any special tools such as presses or crimps, which are commonly used to apply metallic hardware. Secondly, the non-metallic strength applique does not require the use of adhesives or epoxies which require setting/curing time and whose application is craft-dependent. Thirdly, the non-metallic strength applique is non-metallic so as not to interfere with any electrical grounding elements and to prevent degradation due to corrosion.

Although the present disclosure will generally be described using a primary example, it will be appreciated that alternatives and/or improvements to the primary embodiment are possible. For example, one modification could include additional gripping layers in the event that multiple cable layers require enhanced interlayer mechanical coupling. The present disclosure could utilize alternative non-metallic materials, or even metallic materials, if desirable for the application. The alternative materials can be selected for appropriate strength, and should preferably not impact the physical structure, or optical/mechanical performance, of the cable joint/coupling. Furthermore, although the present disclosure will be described in the context of connecting two optical cables using a termination assembly, it will be understood that the termination assembly may additionally, or alternatively, be used to electrically ground the optical cable(s).

Although not limited to any particular commercial application, embodiments of the present disclosure may be useful for Deep Water Extra Protected (DXP) cables, such as the SL17 DXP cable from SubCom®. The embodiments of the present disclosure may also be useful for SubCom's Millennia® Joint.

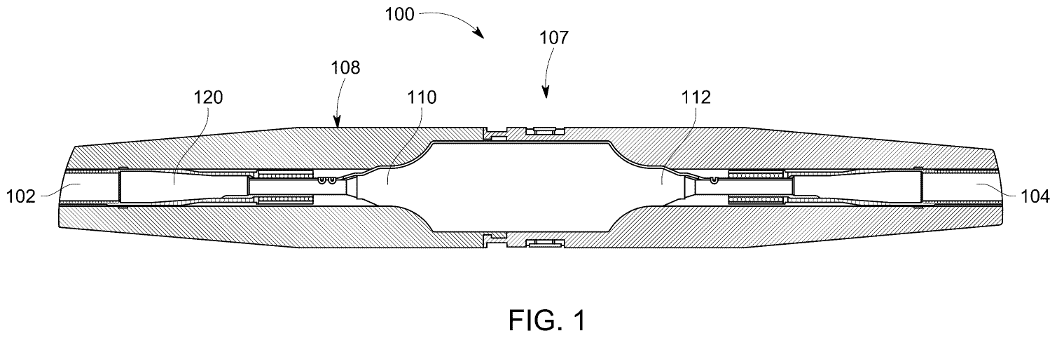

Turning to FIG. 1, a cross section of an example cable joint assembly 100 is shown. The joint assembly 100 may be used to couple together multiple conductor optical cables (hereinafter “cables”) 102, 104, or portions of optical cables, which may connect to undersea devices in optical networks.

As used herein, the terms “couple” or “connect” and variations thereof refer generally to any type of electrical and/or mechanical connection and do not necessarily require a direct physical connection. The terms “coupling” and “joint” as used herein are also not limited to any particular type of undersea device.

Although not shown in detail here, the optical cables 102, 104 may include optical fibers surrounded by a tube and one or more layers of strength members (e.g., wire layers). The optical fibers may include any type of optical fibers capable of carrying optical signals and providing suitable dispersion characteristics, as is known to those skilled in the art. The tube may be made of a polymer such as polycarbonate or polyamide, or a metal such as stainless steel, copper, or aluminum. The tube may also include a gel, such as a thixotropic, water-blockable gel, surrounding the optical fibers. The strength members may include first and second layers of high strength steel wires with water-blocking material in the interstices between the wires. In one embodiment, a first layer of strength members may include a plurality of wires and a second layer of strength members may include a plurality of wires of one diameter circumferentially alternating with a plurality of wires of a smaller diameter.

In this example, the joint assembly 100 may include a joint 107 having an inner housing and other protective materials. The inner housing may further include splice equipment and other hardware used for optical splicing and mechanical connections. The joint assembly 100 may be overmolded to form an insulating layer on the housing and on portions of each cable end 102, 104 to form respective overmolded insulating portions 110 and 112, for example, from suitable dielectric moldable materials. A boot assembly 108 may further be included external to the joint overmold, also made from suitable dielectric materials.

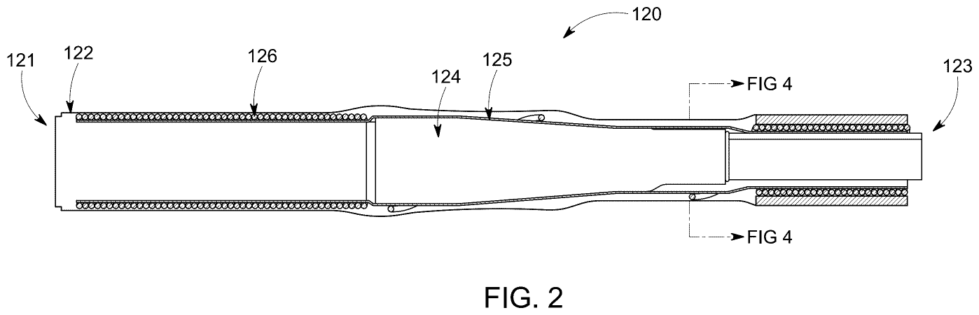

Referring to FIGS. 1-2, the joint assembly 100 may further include a termination assembly 120 near the connection of the optical cable 102 and the joint 107. As best shown in FIG. 2, the termination assembly 120 may include a first end 121 and a second end 123, wherein the second end 123 is proximate the joint 107 and the first end 121 corresponds to the length of the cable 102 extending away from the joint 107. At the first end 121 may be a cable jacket 122 (e.g., high-density polyethylene), which is adjacent and partially underneath a heat shrink layer or tube 124. Although not shown, the heat shrink tube 124 may surround one or more layers of metal tape (e.g., steel) integrated into the cable structure. Surrounding a portion of the cable jacket 122, the heat shrink tube 124 and a portion of the cable core 123 is a non-metallic gripping layer 125, which may be Kevlar in some embodiments. More specifically, in some embodiments, the gripping layer 125 may be a 2″ braided Kevlar biaxial sleeve.

As further demonstrated, a layer or winding of a non-metallic material 126 (e.g., polypropylene yarn) may be wrapped around the gripping layer 125 in the area of the cable jacket 122. In some embodiments, the non-metallic material 126 may be further wrapped around the heat shrink tube 124, and may continue towards the second end 123 of the assembly 120. As demonstrated, in some embodiments, the non-metallic material 126 may be wound more closely together over the cable jacket 122 and cable core 123 than over the heat shrink tube 124. In still other embodiments, the non-metallic material 126 may be completely terminated on both sides of the heat shrink tube 124, without ever winding around it. Embodiments herein are not limited in this context, however.

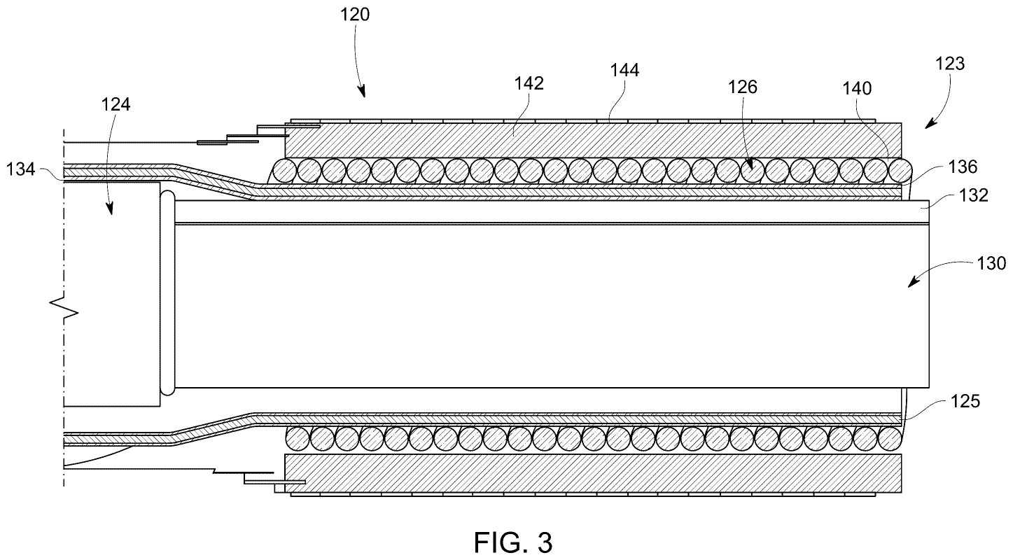

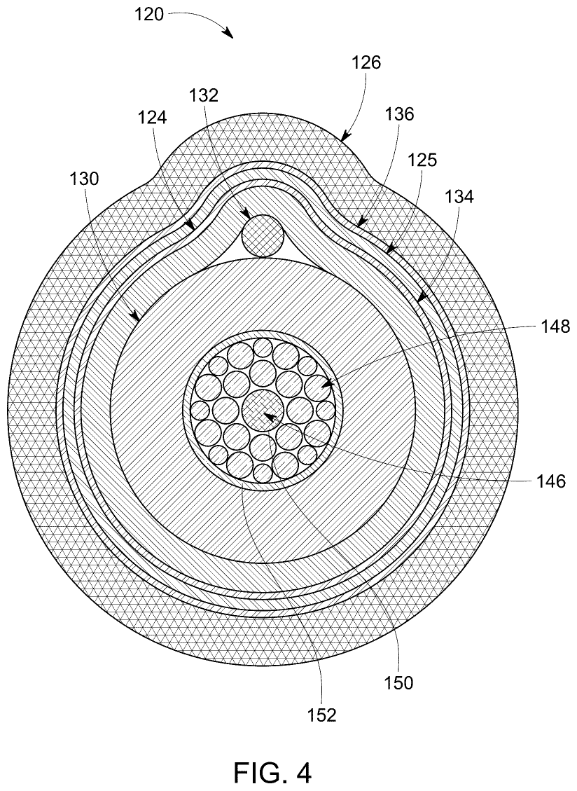

FIGS. 3-4 depict close-up views of the second end 123 of the assembly 120. As shown, the assembly 120 may include a cable core 130 surrounded by the heat shrink tube 124. Between an exterior of the cable core 130 and the heat shrink tube 124 may be a continuity wire 132 (e.g., ground wire). A first tape layer 134 (e.g., friction tape) may surround an exterior of the heat shrink tube 124, and a second tape layer 136 (e.g., friction tape) may surround an exterior of the gripping layer 125. The non-metallic material 126 may then be wrapped over/atop the second tape layer 136. As used herein, friction tape may be a type of woven cloth adhesive tape, sometimes impregnated with a rubber-based adhesive, and typically sticky on both sides.

As best demonstrated in FIG. 3, surrounding the non-metallic material 126 may be a third tape layer 140, which may be vinyl. In some embodiments, a spacer layer 142 may be formed over the non-metallic material 126 prior to application of the third tape layer 140. The spacer layer 142 is secured in place by a single wrap of vinyl 144 or other suitable material.

As best shown in FIG. 4, the core 130 may include a plurality of fibers 146 surrounded by a plurality of strength members 148. The optical fibers 146 may be surrounded by a first tube 150, while the one or more layers of strength members 148 may be surrounded by a second tube 152. Embodiments herein are not limited to any particular number or configuration of fibers 146 and strength members 148, however.

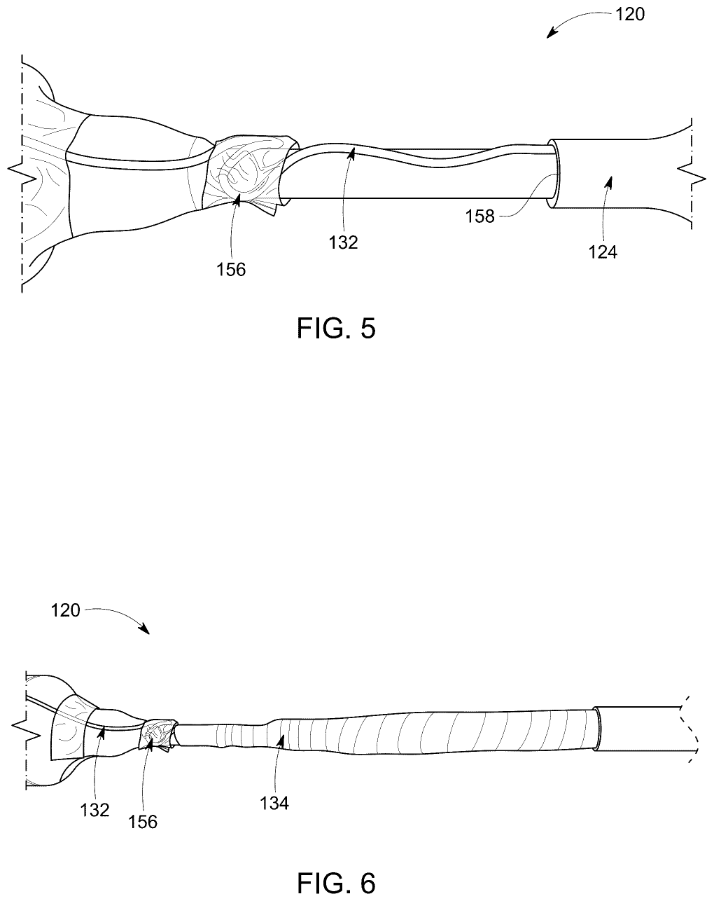

Turning to FIG. 5, an approach for forming the assembly 120 will be described. As shown, the completed tape termination is provided with the heat shrink layer 124 and the ground wire 132. As demonstrated, the ground wire 132 may have an area of slack 156, which may be located approximately 3″ away from an edge 158 of the heat shrink layer 124. In some embodiments, the area of slack 156 may be taped to maintain its configuration during the initial formation process.

FIG. 6 demonstrates the first layer of friction tape 134 applied over the heat shrink layer 124 and the ground wire 132. As shown, the first layer of friction tape 134 may be applied from an unspecified position on the cable outer jacket to approximately 3 inches past the end of the heat shrink layer 124 (e.g., onto the cable core). In some embodiments, each adjacent winding of the first layer of friction tape 134 may have approximately 50% overlap.

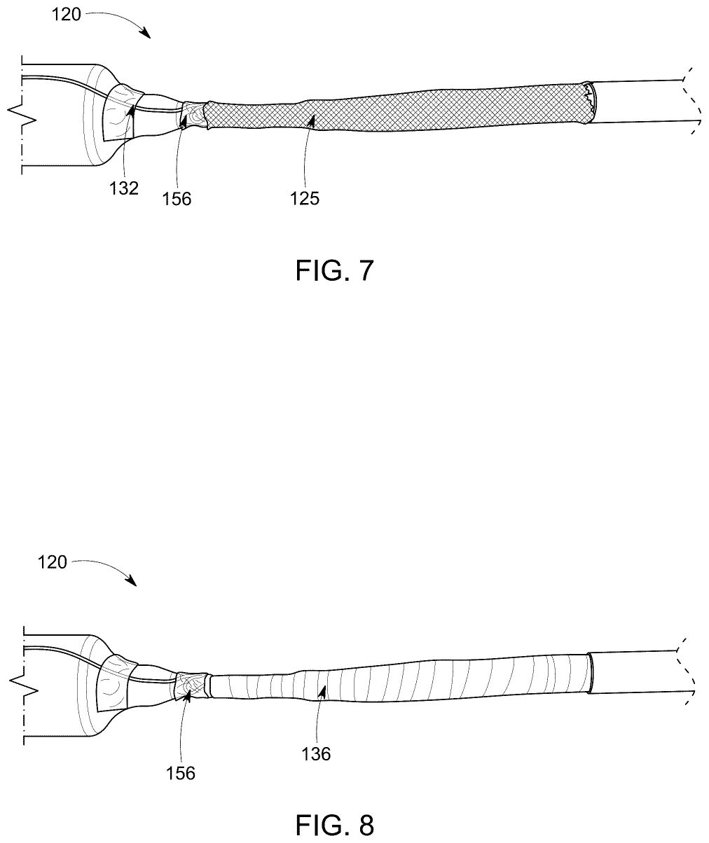

FIG. 7 demonstrates application of the gripping layer 125 over the first layer of friction tape 134. In some non-limiting embodiments, the gripping layer 125 is an approximately 15″ long piece of braided Kevlar tubing positioned such that it completely covers the first layer of friction tape 134. During application, the gripping layer 125 may be smoothed while the slack is taken out along the cable axis.

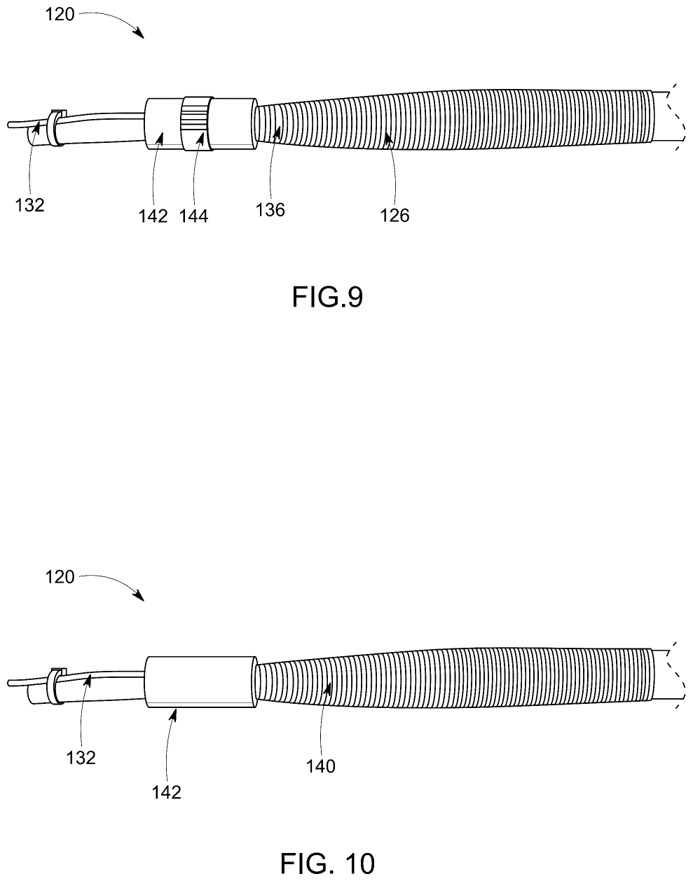

FIG. 8 demonstrates the second layer of friction tape 136 formed over the gripping layer 125, while FIG. 9 demonstrates the formation of the non-metallic material 126 (e.g., yarn) around the second layer of friction tape 136. In some embodiments, the yarn is applied over the entire length of the friction tape/Kevlar tube. In some embodiments, the entire length of friction tape is covered by the yarn. In some embodiments, each adjacent winding of the second layer of friction tape 136 may have approximately 50% overlap.

As further shown in FIG. 9, the spacer layer 142 may then be provided over the non-metallic material 126. In some embodiments, the spacer layer 142 may be secured in place by a single wrap of vinyl tape, which is wrapped around an exterior of the spacer layer 142. In some embodiments, the spacer layer 142 may be assembled between the end of the heat shrink layer 124 and the ground wire slack area 156.

As shown in FIG. 10, the third tape layer 140 is then wrapped around the spacer layer 142 and around the non-metallic material 126. Although non-limiting, the third tape layer 140 may be vinyl, wherein adjacent windings of the vinyl provide an area of overlap. In some embodiments, each adjacent winding of the third tape layer 140 may have approximately 50% overlap.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Furthermore, identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

The terms “substantial” or “substantially,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A joint assembly, the joint assembly comprising:
a boot assembly; and
a termination assembly adjacent a joint, the termination assembly operable to electrically connect and/or electrically ground a first optical cable and a second optical cable, wherein the termination assembly comprises:
a heat shrink layer surrounding a core of the first optical cable, wherein the core comprises a plurality of fibers surrounded by a plurality of strength members;
a first tape layer formed around the heat shrink layer;
a non-metallic gripping layer formed over the first tape layer;
a second tape layer formed over the non-metallic gripping layer; and
a non-metallic material formed over the second tape layer.

2. The joint assembly of claim 1, wherein the termination assembly further comprises a continuity wire positioned between the core and the heat shrink layer.

3. The joint assembly of claim 1, wherein the termination assembly further comprises:
a spacer layer provided over the non-metallic material; and
a third tape layer provided over the spacer layer and over the non-metallic material.

4. The joint assembly of claim 3, further comprising a wrap of vinyl tape around an exterior of the spacer layer, wherein the wrap of vinyl tape is operable to retain the spacer layer in place prior to application of the third tape layer.

5. The joint assembly of claim 3, wherein the first and second tape layers are friction tape, and wherein the non-metallic gripping layer comprises braided synthetic aramid fibers.

6. The joint assembly of claim 3, wherein the non-metallic material comprises polypropylene, and wherein the third tape layer is vinyl.

7. The joint assembly of claim 3, wherein the continuity wire comprises an area of slack located adjacent an end of the spacer layer.

8. The joint assembly of claim 1, wherein the non-metallic material is a yarn wrapped directly around the second tape layer.

9. A termination assembly for connecting and/or grounding optical cables, the termination assembly comprising:
a heat shrink layer surrounding a core of an optical cable;
a first tape layer formed around the heat shrink layer;
a non-metallic gripping layer formed over the first tape layer;
a second tape layer formed over the non-metallic gripping layer;
a non-metallic material formed over the second tape layer; and
a spacer layer formed over the non-metallic material.

10. The termination assembly of claim 9, further comprising a continuity wire positioned between the core and the heat shrink layer.

11. The termination assembly of claim 10, further comprising a third tape layer provided over the spacer layer and over the non-metallic material.

12. The termination assembly of claim 11, further comprising a single wrap of vinyl tape wrapped around an exterior of the spacer layer, wherein the single wrap of vinyl tape is operable to retain the spacer layer in place prior to application of the third tape layer.

13. The termination assembly of claim 11, wherein the continuity wire comprises an area of slack located adjacent an end of the spacer, and wherein the continuity wire is operable to connect the optical cable with a second optical cable.

14. The termination assembly of claim 11, wherein the first and second tape layers are friction tape, wherein the non-metallic gripping layer comprises braided synthetic aramid fibers, wherein the non-metallic material comprises a polypropylene yarn, and wherein the third tape layer is vinyl.

15. A method of forming a termination assembly for an undersea cable joint, the method comprising:
forming a heat shrink layer around a core of the undersea cable, wherein the core comprises a plurality of fibers surrounded by a plurality of strength members;
wrapping a first tape layer around the heat shrink layer;
forming a non-metallic gripping layer over the first tape layer;
wrapping a second tape layer over the non-metallic gripping layer;
forming a non-metallic material over the second tape layer;
forming a spacer layer over the non-metallic material; and
wrapping a third tape layer over the spacer layer and over the non-metallic material.

16. The method of claim 15, further comprising providing a continuity wire between the core and the heat shrink layer.

17. The method of claim 15, further comprising providing a single wrap of vinyl tape around an exterior of the spacer layer, wherein the single wrap of vinyl tape is operable to retain the spacer layer in place prior to formation of the third tape layer.

18. The method of claim 15, wherein the first and second tape layers are friction tape, wherein the non-metallic gripping layer comprises braided synthetic aramid fibers, wherein the non-metallic material comprises a polypropylene yarn, and wherein the third tape layer is vinyl.

19. The method of claim 15, further comprising arranging the continuity wire to include an area of slack located adjacent an end of the spacer layer.

20. The method of claim 15, wherein forming the non-metallic gripping layer over the first tape layer comprises sliding the non-metallic gripping layer over the first tape layer.
